(19) United States
(12) Patent Application Publication
(10) Pub. No.: US 2012/0262632 A1
(43) Pub. Date: Oct. 18, 2012

(54) SYSTEM AND METHOD FOR CLOSED CIRCUIT BROADCASTING

(75) Inventors: Raymond ESKENAZI, Ra'anana (IL); Eran Yarom, Even Yehuda (IL); Dan Farhi, Tel Aviv (IL)

(73) Assignee: ARANEO LTD., Ra'anana (IL)

(21) Appl. No.: 13/398,030

(22) Filed: Feb. 16, 2012

Related U.S. Application Data
(63) Continuation-in-part of application No. PCT/IL2010/000648, filed on Aug. 11, 2010.
(60) Provisional application No. 61/234,239, filed on Aug. 14, 2009.

(51) Int. Cl. H04N 5/46

(52) U.S. Cl. 348/729; 348/E05.114

(57) ABSTRACT

A computer implemented method for closed circuit TV broadcasting which comprises selecting content e.g. Internet content to be broadcast, scheduling the content to be broadcast as a closed circuit TV broadcast via channels in a plurality of sites, and distributing the content to a plurality of sites.

### REFERENCE TO CO-PENDING APPLICATIONS

This application is a continuation-in-part type national phase application maturing from PCT Application No. PCT/IL2010/000648 “Improved system and method for closed circuit broadcasting” which claims priority from U.S. provisional application No. 61/234,329, filed Aug. 17, 2009 and entitled “Improved System and method for closed circuit broadcasting”.

### FIELD OF THE INVENTION

The present invention relates to broadcast TV and in particular to closed circuit broadcast TV.

### BACKGROUND OF THE INVENTION

Closed circuit television (CCTV) is a method for transmitting a signal to a specific place, on a limited set of monitors. This method differs from broadcast television because the signal is not openly transmitted, though it may employ point-to-point-wireless links. One usage of CCTV is for broadcasting content to campuses. Such campuses may be for example hotels, cruise ships, hospitals and the like. In hotels and cruise ships, this method may be used for broadcasting video content to guests.

Methods known in the art for closed circuit TV comprise broadcasting of content via satellite or via channels to a plurality of sites (campuses).

U.S. Pat. No. 5,970,386 issued Oct. 19^{th} 1999, describes a system for redistributing a broadband audio-visual-data signal to a multiplicity of receiver units within a multiple dwelling unit (MDU) which includes a main receiving antenna that receives a broadband video/audio/data signal having a number of individual program multiplex signals therein and a transmodulator device that transmodulates the individual program multiplex signals associated with the broadband signal from a first modulation scheme to a second modulation scheme to reduce the bandwidth of the broadband signal. The trans-modulated signals are broadcast over a cable network, along with terrestrial signals, to individual receiver units at the MDU. The receiver units demodulate the trans-modulated and/or terrestrial signals and provide user-specified channels to television sets for display.

The disclosures of all publications and patent documents mentioned in the specification, and of the publications and patent documents cited therein directly or indirectly, are hereby incorporated by reference.

### SUMMARY OF THE INVENTION

Certain embodiments of the invention seek to provide a method for playing movies and turn the movies into a digital broadcast.

Certain embodiments of the invention seek to broadcast over several channels on a cost-effective platform.

Certain embodiments of the invention seek to remotely insert real time advertisements and/or variety of TV content, to TV broadcasts, through a computerized network such as the Internet.

Certain embodiments of the invention seek to cost-effectively provide content and advertisements scheduling for hotel platforms.

Certain embodiments of the invention seek to provide 100% control via the Internet for advertisers and TV broadcasts or by using web pages.

Certain embodiments of the invention seek to remotely and efficiently update content, e.g. for cost-effective broadcasting in hotel rooms.

Certain embodiments of the invention seek to provide a muxer which can multiplex several streams into multiple channels as opposed to conventional muxers which mux multiple streams into a single channel.

Certain embodiments of the invention seek to provide a muxer with a splicing mechanism.

Certain embodiments of the invention seek to provide a muxer which muxes streams in real-time as opposed to conventional muxers which work on files.

According to some embodiments of the invention, there is provided a computer implemented method for closed circuit TV broadcasting, the method comprising selecting content to be broadcast, scheduling the content to be closed circuit TV broadcasted via channels, and distributing the content to a plurality of sites. The content comprises Internet content. The Internet content comprises Internet data streaming data and Internet files. The content may comprise files stored on a media. Such media may be, for example, a DVD. The broadcasting of the content is performed via VPN. The content may comprise advertisements. The content is matched to the content groups. The content, or at least a portion of the content, may be provided free of charge.

According to another embodiment of the present invention, there is provided a method for closed circuit broadcasting via terrestrial format comprising converting content from Internet format to suitably formatted digital broadcasts and broadcasting the converted content through cables. According to this embodiment, the broadcasting is closed circuit broadcasting.

According to another embodiment of the present invention there is provided a system for closed circuit broadcasting comprising a central server being functional for choosing content and for scheduling the distribution of the content via channels. The content comprises Internet content. The system also comprises one or more local servers being functional for receiving the distributed content and for broadcasting the content via closed circuit broadcasting according to the scheduling performed by the central server. The system may comprise a Digital TV native decoder configurable for decoding the content to a suitable digital format, and for transmitting the decode content.

Unless otherwise defined, all technical and scientific terms used herein have the same meaning as commonly understood by one of ordinary skill in the art to which this invention belongs. The materials, methods, and examples provided herein are illustrative only and are not intended to be limiting.

Implementation of the methods and systems shown and describe may involve performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, TV decoder, game console, digital music player, ATM (machine for dispensing cash), POS credit card terminal (point of sale), or an electronic cash register. Any two or more of such devices in communication with each other, and/or any computer in communication with any other computer, may optionally comprise a “computer network”.

In accordance with an aspect of the invention, there is provided a computer implemented method for closed circuit TV broadcasting, comprising selecting content to be broadcast, scheduling and programming the content to be closed circuit TV broadcasted via channels, and distributing the content to a plurality of sites over the Internet.

In accordance with an embodiment of the invention, there is provided a method wherein content comprises Internet data streaming.

In accordance with an embodiment of the invention, there is further provided a method wherein the content comprises Internet files.

In accordance with an embodiment of the invention, there is still further provided a method wherein the content comprises media files.

In accordance with an embodiment of the invention, there is still further provided a method wherein the network communication is performed via VPN.

In accordance with an embodiment of the invention, there is still further provided a method wherein the content comprises advertisements.

In accordance with an embodiment of the invention, there is still further provided a method further comprising matching the content into content groups.

In accordance with an embodiment of the invention, there is still further provided a method wherein at least a portion of the content is provided free of charge.

In accordance with an embodiment of the invention, there is still further provided a method further comprising broadcasting the content at each of the plurality of sites according to the scheduling and the programming.

In accordance with an aspect of the invention, there is provided a method for closed circuit broadcasting via terrestrial format, comprising converting content from Internet format to a suitable digital broadcast format, and broadcasting the converted content through cables, wherein the broadcasting is closed circuit broadcasting.

In accordance with a further aspect of the invention, there is provided a system for closed circuit broadcasting, comprising at least one of a central server being functional for choosing content for scheduling the broadcasting of the content, for matching the content into channels and for distributing the content via the Internet, and a local server being functional for receiving the distributed content and for broadcasting the content via closed circuit broadcasting according to the scheduling.

In accordance with an embodiment of the invention, there is further provided a system further comprising a digital TV native decodeconfigurable for decoding the content to a suitable digital format, and for transmitting the decoded content.

In accordance with an embodiment of the invention, there is still further provided a system further comprising additional local servers.

In accordance with an aspect of the invention, there is provided a digital system operative to multiplex and transmit in real time for a plurality of channels.

In accordance with an embodiment of the invention, there is still further provided a system wherein transmission may be implemented over one of the following: DVB standards, ATSC standards, ISDB standards, DTMB standards, DMB standards or any other digital broadcast standard.

In accordance with an aspect of the invention, there is further provided a digital system including some or all of a channel server, a transport stream multiplexer (muxer), a re-multiplexer (ReMuxUtil), and a player (e.g. DtPlay).

In accordance with an embodiment of the invention, there is still further provided a system wherein communication between the elements of the digital system employs named pipes.

In accordance with an embodiment of the invention, there is still further provided a system wherein the channel server is operative for setting up the named pipes.

In accordance with an embodiment of the invention, there is still further provided a system wherein the channel server is operative for feeding the multiplexer with input video and audio content according to a preloaded play list on a database.

In accordance with an embodiment of the invention, there is still further provided a system wherein the channel server is operative for transferring a multiplexed transport stream generated by the multiplexer, to the ReMuxUtil, so as to increase the bit rate.

In accordance with an embodiment of the invention, there is still further provided a system wherein the remuxed transport stream is sent to the DtPlay where the TS (transport stream) is encapsulated with a desired broadcast type.

In accordance with an embodiment of the invention, there is still further provided a system wherein the broadcast type includes one of: DVB-t, DVB-c, ATSC.

In accordance with an embodiment of the invention, there is still further provided a system wherein the TS (transport stream) is transmitted over an RF signal.

In accordance with an embodiment of the invention, there is still further provided a system wherein the TS (transport stream) is transmitted over the RF signal using a DTA-110T or DTA-111 PCI card.

In accordance with an embodiment of the invention, there is still further provided a system wherein the transport stream multiplexer reads from several named pipes, each pipe representing a channel.

In accordance with an embodiment of the invention, there is still further provided a system wherein each channel includes a video and an audio stream and wherein the input video and audio are extracted and split into frames.

In accordance with an embodiment of the invention, there is still further provided a system wherein each of the frames is split to fit the transport stream packet size minus the transport stream packet header size.

In accordance with an embodiment of the invention, there is still further provided a system wherein periodically, a PCR (Program Clock reference) is inserted into the transport stream header of video packets.

In accordance with an aspect of the invention, there is still further provided a splicing system operative, if a certain video frame has a PTS (Presentation Time Stamp, extracted from the MPEG frame itself) which is lower than the previous PTS, to mark the certain frame as a new input for the channel.

In accordance with an embodiment of the invention, there is still further provided a system wherein a splicing point may be counted down before insertion to the transport stream.

In accordance with an embodiment of the invention, there is still further provided a system wherein if there is no efficient way of detecting an end of stream countable as TS packets, a blank frame is injected.

In accordance with an embodiment of the invention, there is still further provided a system wherein the blank frame is split into transport stream packets, and each of the packets includes a Splicing Point Flag turned on and a Splice Countdown integer set, indicating how many TS packets from each one a splicing point occurs.

In accordance with an embodiment of the invention, there is still further provided a system comprising a PAT (Program Association Table), which contains information regarding the channels.

In accordance with an embodiment of the invention, there is still further provided a system comprising a PMT (Program Map Table) which contains specific information regarding each channel.

In accordance with an embodiment of the invention, there is still further provided a system wherein the tables are inserted periodically into the transport stream.

In accordance with an embodiment of the invention, there is still further provided a system comprising an EIT (Event Information Table) table used to transmit EPG (Electronic Program Guide) over a transport stream.

In accordance with an embodiment of the invention, there is still further provided a system wherein the EPG information is taken from a local database which has the playlist guide for all channels.

In accordance with an embodiment of the invention, there is still further provided a system wherein the EIT is inserted periodically.

In accordance with an embodiment of the invention, there is still further provided a system wherein every elementary stream (video or audio) is represented in the TS as often as possible, in order to prevent starvation of an ES.

In accordance with an embodiment of the invention, there is still further provided a system wherein an entire frame of an ES cannot be split into packets and dumped into the TS one after the other.

In accordance with an embodiment of the invention, there is still further provided a system wherein each TS packet is inserted into a channel queue and wherein, once all of the channel queues contain over a predetermined number of packets each, flushing of the packets takes place.

In accordance with an embodiment of the invention, there is still further provided a system wherein, when flushing, a packet is popped from each channel queue and inserted into the transport stream.

In accordance with an embodiment of the invention, there is still further provided a system wherein the flushing is effected using a round robin type algorithm, which typically ensures that each channel has an equal packet consistency in the muxed transport stream.

In accordance with an embodiment of the invention, there is still further provided a system wherein the round robin type algorithm also takes into account the number of elements in each queue.

In accordance with an embodiment of the invention, there is still further provided a system wherein the round robin type algorithm ensures that all the queues are drained.

In accordance with an embodiment of the invention, there is still further provided a system wherein the round robin type algorithm ensures that all the queues are well spread within the TS.

In accordance with an embodiment of the invention, there is still further provided a system wherein, before flushing the queues, the audio queue is compared to the video queue to establish the frequency of appearances of the audio queue within the channel.

In accordance with an embodiment of the invention, there is still further provided a system wherein the method goes over all the channels as in a conventional round robin algorithm, and pops on a packet from a channel.

In accordance with an embodiment of the invention, there is still further provided a system wherein the packet comprises either a video or an audio packet, depending on the channel's audio frequency.

In accordance with an embodiment of the invention, there is still further provided a system wherein the muxed TS may then undergo re-multiplexing in the ReMuxUtil.

In accordance with an embodiment of the invention, there is still further provided a system wherein null packets are added to ensure that the stream maintains a constant bit rate.

In accordance with an embodiment of the invention, there is still further provided a system wherein the payload of the null packets contains no data and the receiver ignores its contents.

In accordance with an embodiment of the invention, there is still further provided a system wherein the player (e.g. DtPlay) sets at least one of the encapsulating broadcast type, the RF frequency and other broadcast specific settings, and transmits the TS.

In accordance with an embodiment of the invention, there is still further provided a system wherein the player transmits the TS using a DTA-110T or DTA-111 PCI card.

Also provided is a computer program product, comprising a computer usable medium or computer readable storage medium, typically tangible, having a computer readable program code embodied therein, the computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. Any or all functionalities of the invention shown and described herein may be performed by a conventional personal computer processor, workstation or other programmable device or computer or electronic computing device, either general-purpose or specifically constructed, used for processing; a computer display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure.

Other embodiments of the invention include:

Embodiment 1. A computer implemented method for closed circuit TV broadcasting, comprising:

selecting content to be broadcast;

scheduling and programming said content to be closed circuit TV broadcasted via channels; and

distributing said content to a plurality of sites over the Internet.

Embodiment 2. The method of embodiment 1 wherein content comprises Internet data streaming.

Embodiment 3. The method of embodiment 1 wherein said content comprises Internet files.

Embodiment 4. The method of embodiment 1 wherein said content comprises media files.

Embodiment 5. The method of embodiment 1 wherein said Internet broadcasting is performed via VPN.

Embodiment 6. The method of embodiment 1 wherein said content comprises advertisements.

Embodiment 7. The method of embodiment 1 further comprising matching said content into content groups.

Embodiment 8. The method of embodiment 1 wherein said scheduling and programming comprises using a processor for creating a “family” of computerized playlists including a plurality of playlists, each including movies and embedded commercials, for each of a corresponding plurality of screening locations.

Embodiment 9. The method of embodiment 1 further comprising broadcasting said content at each of said plurality of sites according to said scheduling and said programming

Embodiment 10. A method for closed circuit broadcasting via terrestrial format, comprising:
converting content from Internet format to digital format; and
broadcasting said converted content through cables; wherein said
broadcasting is closed circuit broadcasting.

Embodiment 11. A system for closed circuit broadcasting; comprising at least one of:

at least one central server being functional for choosing content for scheduling the broadcasting of said content, for matching said content into channels and for distributing said content via the Internet; and

a local server being functional for receiving said distributed content and for broadcasting said content via closed circuit broadcasting according to said scheduling.

Embodiment 12. The system of embodiment 11; further comprising a digital TV native decoder configurable for decoding said content to digital format and for transmitting said decoded content.

Embodiment 13. The method of embodiment 8, wherein said creating a “family” of computerized playlists comprises:

providing a computerized master playlist including:
video files respectively representing movies; and
video-less placeholders for commercial breaks;

providing a database of video files representing campaigns, including, for at least an individual video file from among the video files, an indication of relevance of said individual video file to at least some of the plurality of screening locations and an indication of said individual video file's priority relative to at least one video file other than said individual video file; and

for each individual screen location from among said screen locations, using a processor to generate a screen location-specific version of the master playlist characterized in that campaigns relevant the screen location are included in the playlist.

Embodiment 14. A digital system that supports one or many digital broadcasting standards and is operative to multiplex and transmit in real time for a plurality of channels.

Embodiment 15. The method of embodiment 13 wherein said processor is operative as follows:
for each of said video files in said master playlist, generating a file entry using the video file's path;
for each individual placeholder from among said video-less placeholders, creating at least one entry in the playlist within the placeholder, including selecting video files, to constitute said at least one entry, from the database, in order of priority and only if relevant to said individual screening location;
if eventual playlist length exceeds a predetermined length, trimming at least one movie from the playlist until said eventual playlist length no longer exceeds the predetermined length; and
modifying the playlist by delaying each movie's starting point to a rounded starting time.

Embodiment 16. The method of embodiment 15 wherein said providing a database of video files representing campaigns includes providing, for each of said video files, a binary data field recording a relevant/not relevant indication for each of the plurality of screening locations.

Embodiment 17. A digital system according to embodiment 14 that supports one or many digital broadcasting standards such as but not limited to DVT/T, DVB/T2, ATSC, ISDB-T or DMB-T/H and includes all or any subset of:

a transport stream multiplexer (muxer) for generating multiplexed transport stream from input streams,

a channel server for audio/video content acquisition and feeding the content to the multiplexer according to a preloaded playlist,

a re-multiplexer for receiving the multiplexed transport streams from the muxer and normalizing their bit-rate;

a player for encapsulating the transport stream with the desired digital broadcast type; and
A Transmitter that allows transmitting a digital broadcast that originates from the player.

Embodiment 18. The system of embodiment 17 wherein the TS (transport stream) is transmitted over an RF signal.

Embodiment 19. The system of embodiment 17 wherein periodically, a PCR (Program Clock reference) is inserted into the transport stream header of video packets.

Embodiment 20. A splicing system operative, if a certain video frame has a PTS (Presentation Time Stamp, extracted from the MPEG frame itself) which is lower than the previous PTS, to mark said certain frame as a new input for the channel.

Embodiment 21. The system of embodiment 20 wherein a splicing point may be counted down before insertion to a transport stream.

Embodiment 22. The system of embodiment 20 wherein if there is no efficient way of detecting an end of stream countable as TS packets, a blank frame is injected.

Embodiment 23. The system of embodiment 22 wherein the blank frame is split into transport stream packets, and each of the packets includes a Splicing Point Flag turned on and a Splice Countdown integer set, indicating how many TS packets from each one a splicing point occurs.

Embodiment 24. A system according to embodiment 17 and also comprising a PAT (Program Association Table), which contains information regarding the channels and is inserted periodically into the transport stream.

Embodiment 25. A system according to embodiment 17 and also comprising a PMT (Program Map Table) which contains specific information regarding each channel.

Embodiment 26. A system according to embodiment 17 and also comprising An EIT (Event Information Table) table used to transmit EPG (Electronic Program Guide) information over a transport stream.

Embodiment 27. The system of embodiment 26 wherein said EPG information is taken from a local database which has a playlist guide for all channels.

Embodiment 28. A system according to embodiment 17 wherein every elementary stream (video or audio) is represented in the TS as often as possible, in order to prevent starvation of an ES.

Embodiment 29. A system according to embodiment 17 wherein the muxed TS may then undergo re-multiplexing in the ReMuxUtil.

Embodiment 30. The system of embodiment 29 wherein null packets are added to ensure that the stream maintains a constant bit rate.

Embodiment 31. The system of embodiment 30 wherein the payload of said null packets contains no data and the receiver ignores its contents.

Embodiment 32. The system of embodiment 17 wherein the player (DtPlay) sets at least one of the encapsulating broadcast type, the RF frequency and other broadcast specific settings, and transmits the TS.

Embodiment 33. A system according to embodiment 21 and also comprising a PAT (Program Association Table), which contains information regarding the channels.

Embodiment 34. A system according to embodiment 21 and also comprising a PMT (Program Map Table) which contains specific information regarding each channel.

Embodiment 35. The system of embodiment 25 wherein said tables are inserted periodically into the transport stream.

Embodiment 36. A system according to embodiment 21 and also comprising an EIT (Event Information Table) table used to transmit EPG (Electronic Program Guide) over a transport stream.

Embodiment 37. A system according to embodiment 21 wherein every elementary stream (video or audio) is represented in the TS as often as possible, in order to prevent starvation of an ES.

Embodiment 38. The method of embodiment 15 wherein said predetermined length comprises 24 hours.

Embodiment 39. The method of embodiment 15 wherein said delaying defines blank time intervals and wherein said modifying also comprises inserting into the playlist, portions of a pre-stored filler item to fill the blank time intervals.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a high-level flow diagram of a method for closed circuit TV broadcasting according to embodiments of the present invention.

FIG. 2 is a schematic drawing of a typically hard-ware based system for closed circuit TV broadcasting according to embodiments of the present invention, useful e.g. in conjunction with the methods of FIGS. 1, 3-6.

FIG. 3 is a more detailed diagram of a method for closed circuit TV broadcasting according to embodiments of the present invention which may be suitable for implementing the method of FIG. 1.

FIG. 4 is an exemplary diagram of a method for building a play list according to embodiments of the present invention.

FIG. 5 is a high-level flow diagram of a method for managing advertisement according to embodiments of the present invention, including a method for accepting an advertiser and finding an appropriate advertising package therefor.

FIG. 6 is a high-level flow diagram of a method for inserting advertisements to content according to embodiments of the present invention, including a suitable method for implementing the two final stages of FIG. 5.

FIGS. 7 and 8 illustrate a system for improved closed circuit TV broadcasting according to certain embodiments of the present invention, e.g. using any or all of the methods of FIGS. 1, 3-6.

FIG. 9 is a simplified flowchart illustration of a method for Automatic Playlist family Creation according to certain embodiments of the present invention.

FIGS. 10a-10b, taken together, form a simplified flowchart illustration of a method for building a playlist automatically, according to certain embodiments of the present invention.

FIG. 11 is a simplified flowchart illustration of a method for computerized Placeholder assignment, according to certain embodiments of the present invention.

FIG. 12 is a simplified flowchart illustration of a method for computing optimal-timespan useful for providing “rounded” movie start times, according to certain embodiments of the present invention.

Computational components described and illustrated herein can be implemented in various forms, for example, as hardware circuits such as but not limited to custom VLSI circuits or gate arrays or programmable hardware devices such as but not limited to FPGAs, or as software program code stored on at least one intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Data can be stored on one or more intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

The present invention comprises a system and method for closed circuit broadcast TV. The methods represented in the flow diagrams typically comprise some or all of the illustrated steps, suitably ordered e.g. as shown.

According to some embodiments of the present invention, the system and method provides the distributing of content from one or more central locations to one or more sites to be broadcasted in a closed circuit TV at each site. The distributing from the central location to the sites is performed from a central to local servers over the Internet. The content may be Internet content, content taken from studios and the like. The context may comprise movies, songs, news and may further comprise advertisements, which are preferably matched to the context and to the location in which the content is broadcasted. The site may be a hotel, a hospital, a cruise ship, or any other site (campus) which may be interested in local TV broadcasting. The broadcasting of the content in each site or each group of sites is scheduled. The content is also matched into channels before being distributed to the sites. The matching of content into channels may be implemented specifically per each site or each group of sites. The scheduling and the channel-matching program are also distributed to the sites over the Internet. At each site, the content is broadcasted in channels according to the predefined schedule and channel-matching program. The content is available by choosing a channel on the TV and not upon demand as is common in the art. This type of distribution may have its own media distribution rights. Media distribution rights are rights provided for distributing a certain type of media; for example, distributing movies in cinemas has its own rights, while distributing movies on DVD storage in libraries has its own rights.

The service, or at least a portion of the service, may be provided free of charge and may feature the option for making a profit by inserting advertisements into the content. The content may comprise Internet data content including but not limiting to video, audio and the like. The content may also comprise video and/or audio data that is taken from a media file. The content may be provided by film or audio studios.

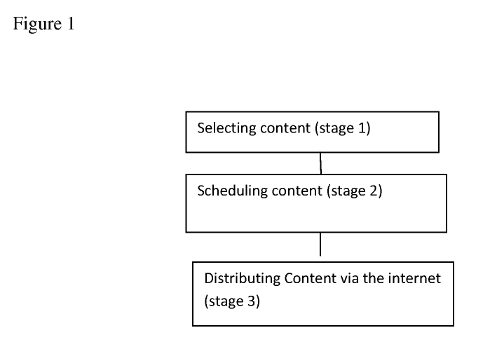

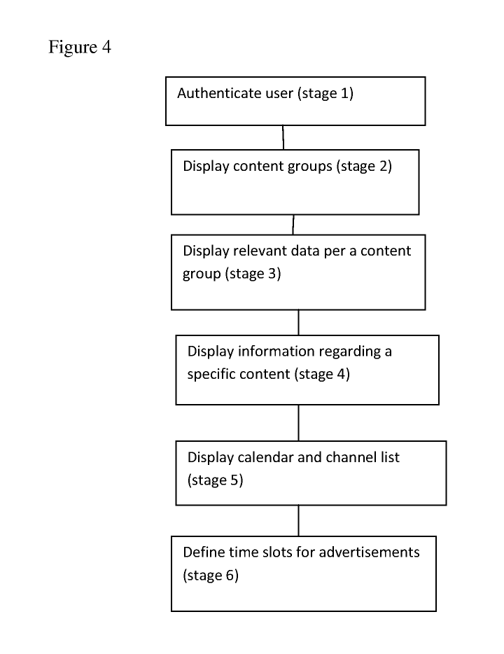

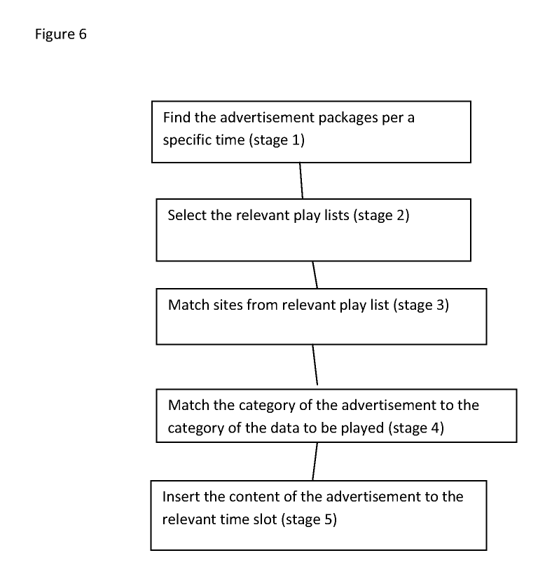

Referring now to the drawings, FIG. 1 is a high-level flow diagram of a method for closed circuit TV broadcasting according to embodiments of the present invention. In stage 1, the content for broadcasting is selected. Such content may be Internet content. Such Internet content may comprise movies, songs and the like. Such Internet content may comprise streaming data, which may be taken from Internet sites such as, for example YouTube. Such Internet content may also comprise video files, which can be downloaded from the Internet to a central server. The content may also comprise media files. The content may be provided by film or audio studios. The files may be saved in a central server for being distributed to a plurality of sites. In stage 2, the content is scheduled and programmed to be closed circuit TV broadcasted via channels. The scheduling and programming process is explained in greater detail in FIG. 4. In stage 3, the content is distributed to the sites over the Internet. It should be noted that each group of sites may have a different content; for example hotels that focus on spa facilities might have different content to hotels that focus on sports facilities. It should also be noted that the content may include advertisements, which are chosen according to the context and according to the location of the sites. The method of inserting advertisements is explained in greater detail in FIG. 6. Stages 1-3 may be repeated for distributing new data.

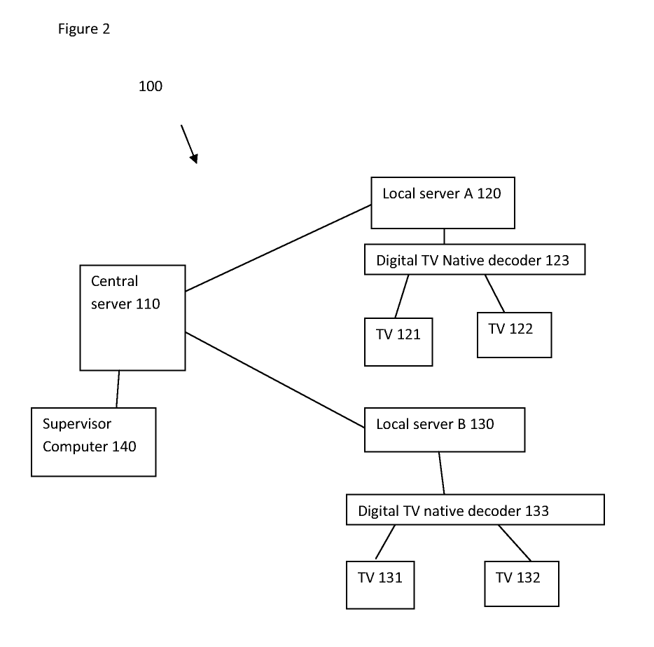

FIG. 2 is a schematic drawing of the system for closed circuit TV broadcasting according to embodiments of the present invention. System 100 features a central server 110 being functional typically for some or all of: for choosing content for scheduling the distribution of the content, for programming the content into channels and for distributing the content to a plurality of sites. The content comprises Internet content media files and the like. The method for choosing the content and for the scheduling is explained in greater detail in FIGS. 1 and 4. The system also features one or more local servers, which may optionally be of any suitable number but of which only two are shown, for the purpose of illustration only, as local server A 120 and local server B 130. Local servers are located at each local site, being functional for receiving the distributed content and for broadcasting the content via closed circuit broadcasting to one or more TVs according to the scheduling and programming defined by the central server. The local server is preferably connected to the Internet for playing streaming data from the Internet according to the predefined schedule and for receiving the content and the scheduled program from the central server 200. Central server 100 and local servers shown as 120 and 130 communicate via the Internet, optionally by using VPN (virtual private network). The broadcasting of data is carried out from each local server to one or more televisions, of which only four are shown, for the purpose of illustration only and without wishing to be limited as TV 121, TV 122, TV 131, and TV 132. The broadcasting of data is optionally carried out via a terrestrial network by using Digital TV native decoder shown as 133 and 123. Broadcasting is preferably digital but may also be analog. Local server 120 and local server 130 decode the data received from central server 110 to a format readable by a Digital TV native decoder. Digital TV native decoder 133 and 123 optionally and preferably decodes the data to a suitable digital format such as but not limited to DVB-T (Digital Video Broadcasting Terrestrial), DVB/T2 or ATSC formats. Data is preferably transferred via a cable to the television sets of the local site. In the exemplary illustration, data is transmitted from Digital TV native decoder 133 to TV 131 and TV 132 and from Digital TV native decoder 123 to TV 121 and TV 122. Alternatively, data may be transferred over the air via a transmitter and an antenna. Central server 110 may be connected to a supervisor computer 140. Such a connection is preferably performed via the Internet. Supervisor computer 140 enables the controlling and monitoring of the system 100 for an authorized user. Such a connection provides an authorized advertiser to advertise its content, preferably via an Internet site. It should be noted that such a system does not require the installation and the usage of set top box per each TV to which the content is distributed.

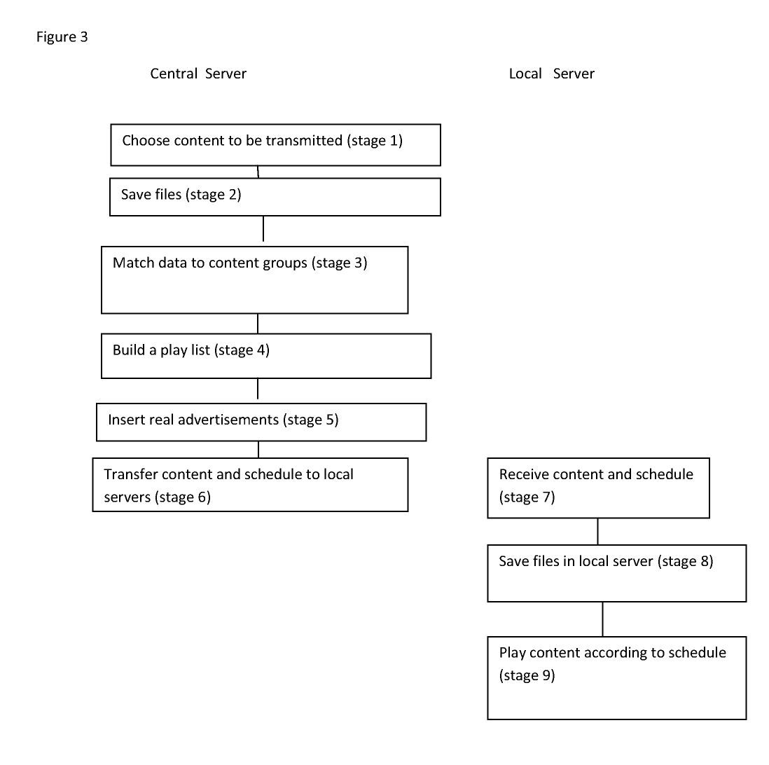

FIG. 3 is a more detailed diagram of a method for closed circuit TV broadcasting, typically of content, according to embodiments of the present invention. In stage 1, the content to be broadcast is chosen. Such content may be Internet content. Such Internet content may comprise movies, songs and the like. Such Internet content may comprise data streaming which may be taken from Internet sites such as, for example YouTube. Such Internet content may also comprise video files, which can be downloaded from the Internet to a central server. The content may comprise media files which may be produced by audio or film studios. In stage 2, the files are saved in storage to be distributed to the sites. In addition to the file, information about the file is optionally saved. Such information may be file length, the sites to which the file is distributed, the category of the file and the like. File data is sorted according to categories, such as data related to children, data related to sports and the like. In stage 3, the data is matched to content groups.

A content group is a list of sites to which the same content is distributed. Such a content group may be, for example, a network of hotels and the like. In stage 4, one or more play lists are built. A play list is a list of files comprising files to be played, data streaming to be played and a combination thereof. A play list also defines the scheduling of playing the files and/or the streaming data. A play list may also define a scheduling for advertising. A play list defines the distribution of the content into channels. A play list may be built per each content group, or may be shared with a plurality of content groups or may be built specifically for a site. The building of the play list is explained in greater detail in FIG. 4. In stage 5, the content of the advertisements is inserted. The method of inserting advertisement content is explained in greater detail in FIG. 6. In stage 6, the content (files) and the play list is distributed to the sites. As explained, per each content group a different content (list of files) and a different play list may be distributed. Stages 1-6 may be repeated for distributing new data. Stages 4-6 may be repeated per each content group or site. Stages 7-8 are performed in each local server to which the content and the play list are distributed. In stage 7, the content and the play list are received at the local server of a site. In stage 8, the files are saved for being played according to the schedule defined in the play list. In stage 9, the content is played and is broadcasted to the television sets belonging to the closed circuit TV. The broadcasting is performed according to the schedule and the channels distribution that is defined in the play list. The files to be played are played from the media in which they were saved. Streaming data is taken from the Internet when it is scheduled to be played. Stages 7-8 are periodically repeated at each local server. The local server may play the already existing content, if a new content is not received after a predefined period (for example after a day). It should be noted that the central server periodically monitors the local servers and the local servers' content.

FIG. 4 is an exemplary diagram of a method for building a play list according to embodiments of the present invention. A play list is a list of content comprising files to be played, streaming data to be played and a combination thereof. A play list also defines the scheduling of playing files and/or the streaming data. A play list may also define a scheduling for advertising. A play list also defines the matching of the content into channels. A play list may be built per each content group, or may be shared with a plurality of content groups or may be built specifically for a site. In stage 1, the system authenticates the user that logs into the system. A user may be an operator who is authorized for building the play lists. In stage 2, the content groups are displayed for the user in order to choose one or more content groups to which the play list is assigned. A content group is a list of sites to which the same content is distributed. Such a content group may be for example a network of hotels and the like. In stage 3, after the user has chosen one or more content groups, the available data related to this group is displayed. Such data might comprise a list of video files, audio files and the like, which are stored in the system. Such data might also comprise Internet-streaming data, which is played on Internet sites such as You Tube and the like. In stage 4, upon user request, information regarding a specific content is displayed. The information may comprise the length of the film, the context, the length of each episode, the category of the film and the like. In stage 5, upon a user's request, a calendar and channel list is displayed. The display enables the user to choose data to be played, to schedule the play of the chosen data, and to assign data to channels. Such data comprises files and stream data. In stage 6, the system enables the user to define time slots for advertisements. The time slots are later filed with advertisement content as explained in greater detail in FIG. 6.

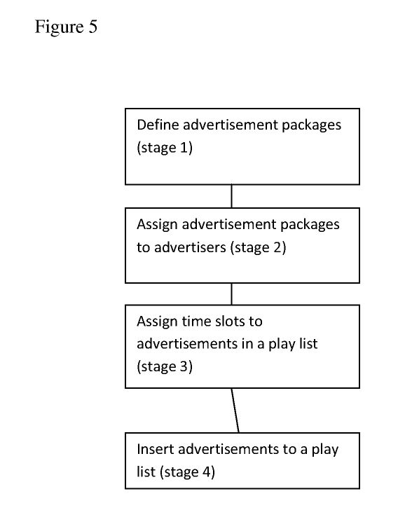

FIG. 5 is a high-level flow diagram of a method for managing an advertisement according to embodiments of the present invention. In stage 1, advertisement packages are defined. An advertisement package comprises the definition of dates in which the advertisement is displayed, the definition of the duration during the day in which the advertisement is displayed, the total display time of the advertisement per day, the sites, the category of the advertisement and the like. In stage 2, advertisement packages are assigned to advertisers. Assigning is preferably performed by using an Internet site. An advertiser may purchase one or more advertisement packages via an Internet site. In stage 3, which is performed as part of the building of the play list, time slots are assigned to advertisements. In stage 4, the content of the advertisement is inserted to the play list according to the definition of the time slots and according to the definition of the advertisement packages, as explained in greater detail in FIG. 6.

FIG. 6 is a high-level flow diagram of a method for inserting advertisements to content according to embodiments of the present invention. In stage 1, the advertisement packages related to a desired broadcast time are chosen. In stage 2, the play lists for the desired broadcast time is selected. In stage 3, a match is performed between the sites that are indicated in the advertisement and the sites to which the play list refer. In stage 4, the category of the advertisement may be matched with the category of the data to be played. In stage 5, the content of the advertisement is inserted to the relevant time slot.

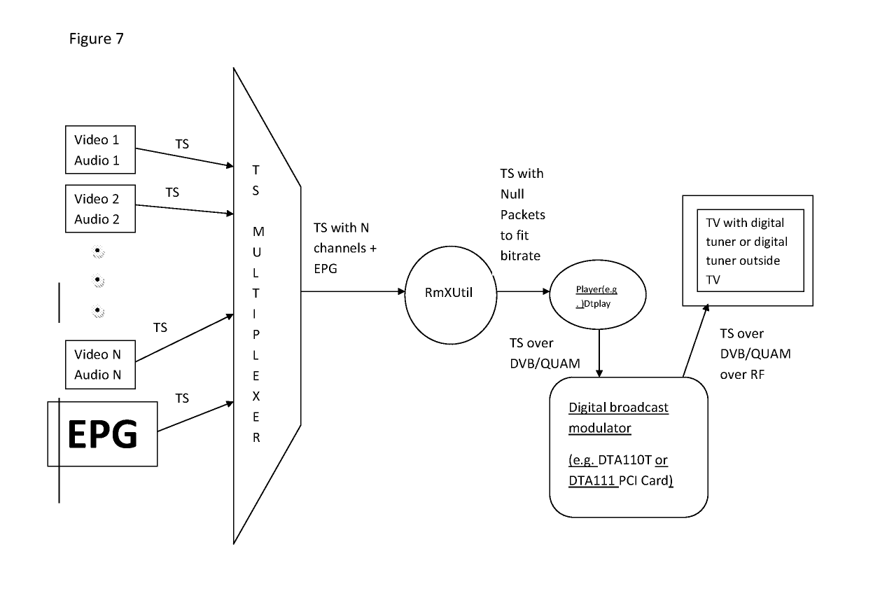

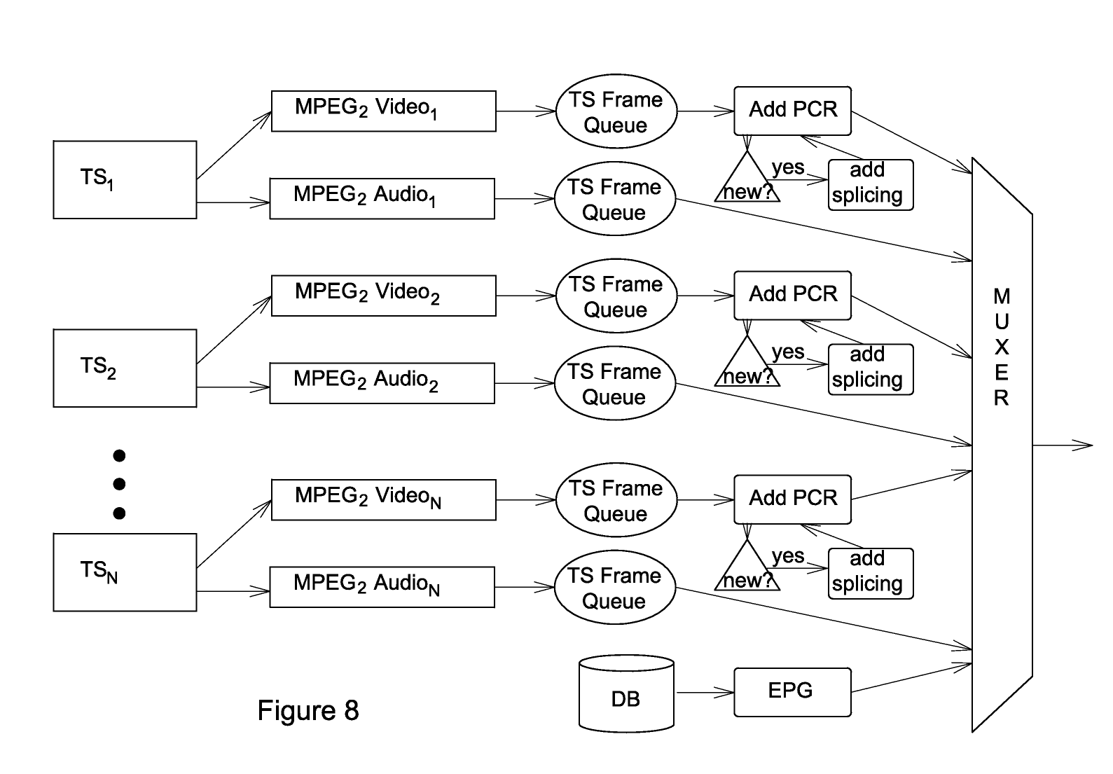

FIGS. 7 and 8 illustrate a system for improved closed circuit TV broadcasting according to certain embodiments of the present invention.

Typically, the digital system of the present invention can multiplex and transmit in real time up to 16 channels, using an x86 standard PC. The system may optionally be implemented entirely in software, without any embedded hardware. Transmission may be implemented over any suitable digital format such as but not limited to DVB-t, DVB-c and ATSC. The system may include a system manager (channel server), a transport stream multiplexer (muxer), a re-multiplexer (ReMuxUtil) and a player (e.g. DtPlay). Communication between the elements of the system may be implemented using named pipes.

The channel server is typically responsible for setting up these named pipes, and for the whole workflow of the system. It feeds the multiplexer with all the input video and audio content according to a preloaded playlist on a database. It then transfers the multiplexed transport stream to the ReMuxUtil of FIG. 8, to increase the bit rate. Lastly, the remuxed transport stream is sent to the player (e.g. DtPlay) of FIG. 8 where the TS (transport stream) is encapsulated with the desired broadcast type (DVB-t, DVB-c, etc.), and transmitted over an RF signal using the DTA-110T or DTA-111 PCI card.

Typically, the transport stream multiplexer reads from several named pipes, each pipe typically representing a channel, and including a video and an audio stream. The input video and audio are then extracted and split into frames. Each frame, video or audio, is then split to fit the (say) 188 bytes transport stream packet size minus the transport stream packet header size. Periodically, e.g. every 50 ms, a PCR (Program Clock reference) may be inserted into the transport stream header of video packets.

Severe problems may occur on the transport stream when a new video is encountered e.g. due to a commercial break or onset of a subsequent movie chapter. This may cause frame loss and lip sync problems. To overcome these problems, the transport stream typically includes a splicing mechanism. The term “splicing” is intended to include an operation in which, if a certain video frame has a PTS (Presentation Time Stamp, extracted from the MPEG frame itself) which is lower than the previous PTS, the frame may be marked as a new input for the channel. The splicing point may be counted down before insertion to the transport stream. Since there may be no efficient way of detecting an end of stream countable as TS packets, a blank frame may be injected. The blank frame is split into transport stream packets, and each of the packets has a Splicing Point Flag turned on and the Splice Countdown integer set, indicating how many TS packets from this one a splicing point occurs.

Both PAT (Program Association Table) tables, which contain information regarding the channels, and PMT (Program Map Table) tables, which contain specific information regarding each channel, are inserted every 20 ms into the transport stream. An EIT (Event Information Table) table is used to transmit EPG (Electronic Program Guide) over a transport stream. This information is taken from a local database which has the playlist guide for all channels. The EIT may be inserted periodically, e.g. every 50 ms.

Every elementary stream (video or audio) may be represented in the TS as often as possible, in order to prevent starvation of an ES. According to this embodiment, an entire frame of an ES cannot be split into packets and dumped into the TS one after the other. To overcome this issue, channel queues are used. Each TS packet is inserted into a channel queue. Once all of the channel queues contain over 35 packets each, flushing of the packets takes place, in which, typically, one packet is popped from each channel queue and inserted into the transport stream. This may be effected using a modified round robin like algorithm, which typically ensures that each channel has an equal packet consistency in the muxed transport stream.

Certain embodiments of the present invention seek to provide a muxer which can multiplex several streams into multiple channels as opposed to conventional muxers which mux multiple streams into a single channel, and may include a muxer with a splicing mechanism or a muxer which muxes streams in realtime, as opposed to conventional muxers which work on files.

In conventional round robin, algorithms go over queues (say) to be processed serially, one after the other. The modified round robin which may be used herein also takes into account the number of elements in each queue, typically ensuring that all the queues are drained and are well spread within the TS.

Typically, each channel has 2 queues, one audio and one video; usually the video channel has more packets than the audio channel. Before flushing the queues the audio queue is compared to the video queue to establish the frequency of appearances of the audio queue within the channel. The method may then go over all the channels as in a conventional round robin algorithm, and pops on a packet from a channel, the packet taken being either a video or an audio packet, typically depending on the channel's audio frequency.

Example:

video queue 1=6
audio queue 1=2
video queue 2=8
audio queue 2=4

The TS may then be:

V1,V2,V1,V2,V1,A2,A1,V2,V1,V2,V1,A2,V1,V2,A1 (channel 1 drained), V2,A2,V2,V2,A2 (channel 2 drained).

Since all channels are typically encoded/decoded using the same bit rate, the total queue amount of the channels is similar to one another, but the audio/video ratios may vary.

Due to the limitations and the impositions of strict constant bit rate requirements of some transmission schemes, such as ATSC and DVB, the muxed TS may then undergo re-multiplexing e.g. using the ReMuxUtil of FIG. 8, to add null packets. This typically ensures that the stream maintains a constant bit rate, typically using some additional null packets. The payload of null packets may not contain any data at all, and the receiver is expected to ignore its contents.

Finally the player (e.g. DtPlay) of FIG. 8 sets the encapsulating broadcast type, the RF frequency and other broadcast specific settings, and transmits the TS using the DTA-110T or DTA-111 PCI card.

According to certain embodiments, local servers, which may for example be deployed in respective hotels, perform certain of the functionalities shown and described herein; these communicate with a main or central server e.g. via a computer network which performs other functionalities shown and described herein such as but not limited to some or all of: the first two stages of the method of FIG. 1; stages 1-4 and 7 of the method of FIG. 3; and the methods of FIGS. 4-6. Typically, no infrastructure other than the local server per hotel and central server (e.g. no specialized set-top boxes) is required in order to provide high digital quality broadcasting to all rooms of each hotel; instead, an existing infrastructure is used.

Also provided herein is a computerized method for creating a “family” of playlists, including at least one and typically a plurality of playlists, of movies and embedded commercials, typically for each of a corresponding plurality of screening locations with differing playlist requirements. This process may be performed by a content manager user of the web administration portal of the system which may handle commercials in the web management system as follows:

In the web management module, allow editing of a Movie Structure entity or object which holds at least the video files of a movie and its metadata e.g. as described herein. Special tags may be added inside the movie structure to indicate where in the movie commercial breaks may be added. Typically, the movie structure entity has a playlist of video files for the movie; each video file can be for example a chapter of the movie; and in between the video files it is possible to add placeholders for commercial breaks, each of which may be marked with one or more special tag(s). For example, Type-A tags might indicate commercials that are to be played in the middle of the movie (including, optionally, where within the movie e.g. between chapters 3 and 4) and Type-B tags might indicate commercials to be played between movies e.g. before a movie begins.

“Commercials Campaign” entities or objects may exist in the system to manage commercial campaigns. A commercial campaign entity may hold the name of the campaign, advertiser name, description, start date, end date, selection of hotels and hotel groups authorized for this content manager user, and a table with {commercial video file, tag names and priority}. The priorities may be numbers. Each row in the table typically represents a video file, specific tag names for this video file and priority for this video file. Typically, it is possible to update/remove commercial campaigns. An example method by which commercials may be assigned to movies is described below. In order to see commercials' assignment, it is possible to create a report that shows the generated playlist.

A playlist may be defined in a web administration portal of the system. Typically, rather than manually defining a playlist per channel for each day, a computerized method is employed which builds a playlist e.g. for each of a plurality of hotels or other screening locales and allows automatic embedding of commercials as appropriate per screening location. An example method is described in detail below.

The user may provide or add a playlist for a channel that includes only a sequence of movies one after the other, and a filler at the bottom. Typically, the filler comprises a video file marked as “filler”—meaning that it is used in the system to fill gaps between movies, optionally being repeated each time it is completed and being re-continued where it left off each time it is interrupted before being completed. The playlist is typically created on runtime when the central administration system synchronizes the hotel's playlist. The playlist-synchronization operation may be performed automatically, e.g. periodically such as every hour and/or manually from the administration web portal of the system. The playlist-synchronization operation may operate as described below.

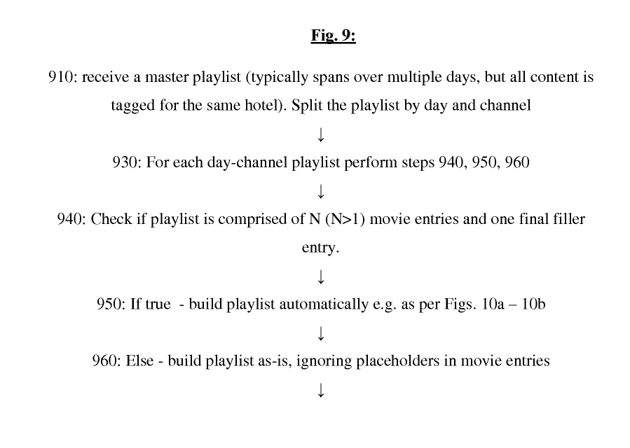

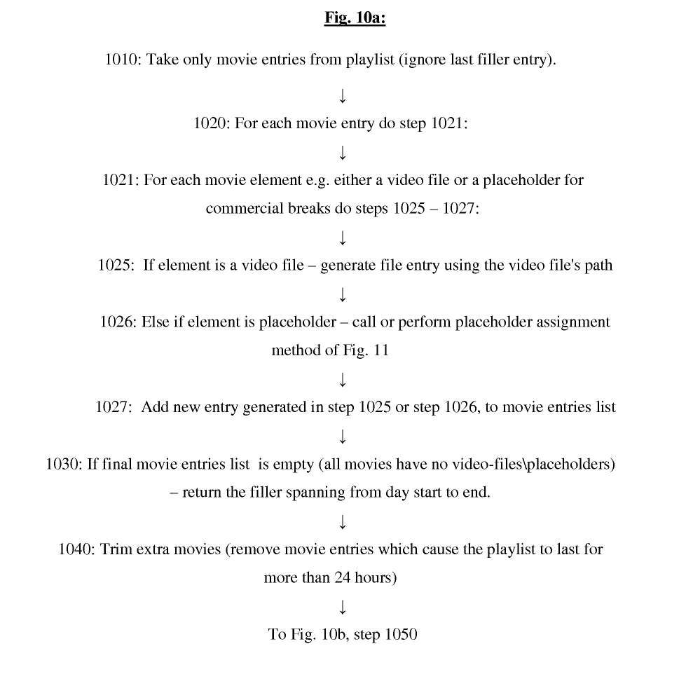

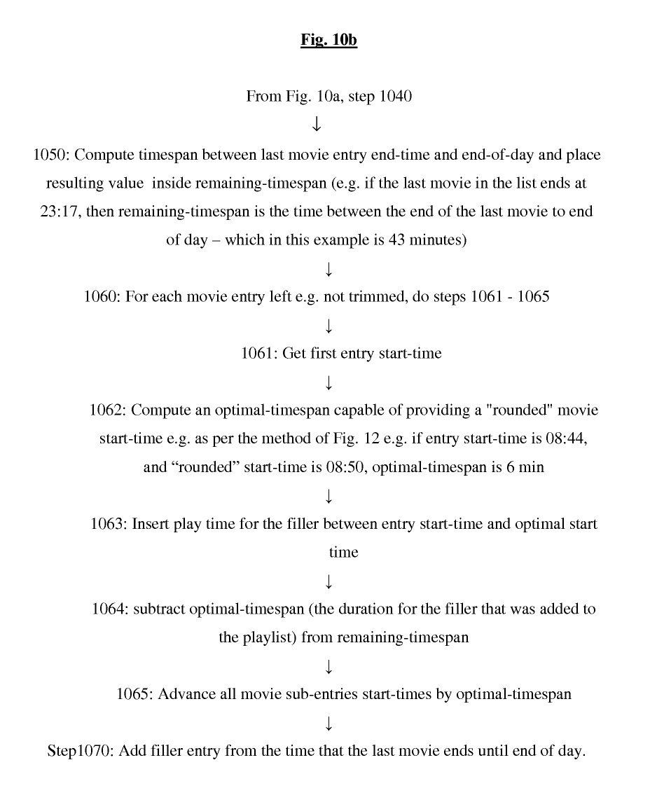

FIG. 9 is a simplified flowchart illustration of a method for automatic playlist family creation according to certain embodiments of the present invention. The method of FIG. 9 typically comprises some or all of the following steps, suitably ordered e.g. as shown:
Step 910: receive a master playlist (typically spans over multiple days, but all content is tagged for the same hotel). Split the playlist by day and channel.
Step 930: For each day-channel playlist perform steps 940, 950, 960:
Step 940: Check if playlist is comprised of N (N>1) movie entries and one final filler entry.
Step 950: If true—build playlist automatically e.g. as per FIGS. 10a-10b
Step 960: Else—build playlist as-is, ignoring placeholders in movie entries

FIGS. 10a-10b, taken together, form a simplified flowchart illustration of a method for building a playlist automatically, according to certain embodiments of the present invention. The method of FIGS. 10a-10b typically comprises some or all of the following steps, suitably ordered e.g. as shown:

Step 1010: Take only movie entries from playlist (ignore last filler entry).
Step 1020: For each movie entry do step 1021:
Step 1021: For each movie element e.g. either a video file or a placeholder for commercial breaks do steps 1025-1027:

Step 1025: If element is a video file—generate file entry using the video file's path

Step 1026: Else if element is placeholder—call or perform placeholder assignment method of FIG. 11

Step 1027: Add new entry generated in step 1025 or step 1026, to movie entries list

Step 1030: If final movie entries list is empty (all movies have no video-files\placeholders)—return the filler spanning from day start to end.

Step 1040: Trim extra movies (remove movie entries which cause the playlist to last for more than 24 hours)

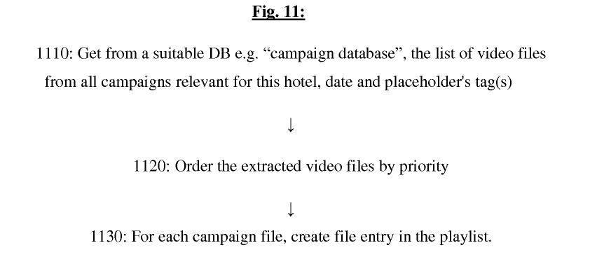

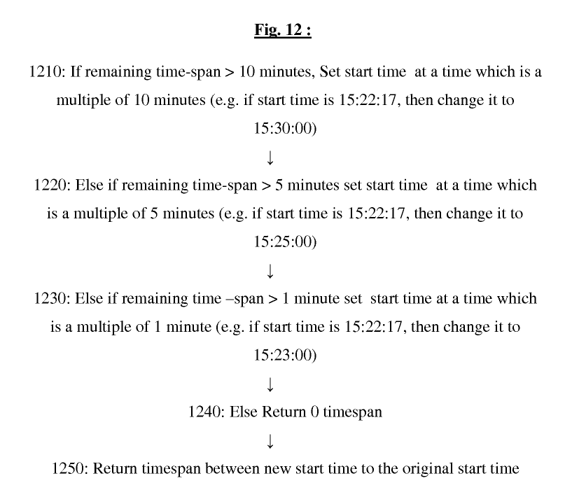

Step 1050: Compute timespan between last movie entry end-time and end-of-day and place resulting value inside remaining-timespan (e.g. if the last movie in the list ends at 23:17, then remaining-timespan is the time between the end of the last movie to end of day—which in this example is 43 minutes)
1060: For each movie entry left e.g. not trimmed, do steps 1061-1065
Step 1061: Get first entry start-time
Step 1062: Compute an optimal-timespan capable of providing a “rounded” movie start-time e.g. as per the method of FIG. 12 e.g. if entry start-time is 08:44, and “rounded” start-time is 08:50, optimal-timespan is 6 min
Step 1063: Insert play time for the filler between entry start-time and optimal start time
Step 1064: subtract optimal-timespan (the duration for the filler that was added to the playlist) from remaining-timespan
Step 1065: Advance all movie sub-entries start-times by optimal-timespan
   Step 1070: Add filler entry from the time that the last movie ends until end of day.

FIG. 11 is a simplified flowchart illustration of a method for computerized Placeholder assignment, according to certain embodiments of the present invention. The method of FIG. 11 typically comprises some or all of the following steps, suitably ordered e.g. as shown:

Step 1110: Get from a suitable DB e.g. “campaign database”, the list of video files from all campaigns relevant for this hotel, date and placeholder's tag(s)

Step 1120: Order the extracted video files by priority

Step 1130: For each campaign file, create file entry in the playlist.

FIG. 12 is a simplified flowchart illustration of a method for computing optimal-timespan which may be used to provide for “rounded” movie start times, according to certain embodiments of the present invention. The method of FIG. 12 typically comprises some or all of the following steps, suitably ordered e.g. as shown:
Step 1210: If remaining time-span>10 minutes, Set start time at a time which is a multiple of 10 minutes (e.g. if start time is 15:22:17, then change it to 15:30:00)
Step 1220: Else if remaining time-span>5 minutes set start time at a time which is a multiple of 5 minutes (e.g. if start time is 15:22:17, then change it to 15:25:00)
Step 1230: Else if remaining time-span>1 minute set start time at a time which is a multiple of 1 minute (e.g. if start time is 15:22:17, then change it to 15:23:00)
Step 1240: Else Return 0 timespan
Step 1250: Return timespan between new start time to the original start time

Typically, the resulting family of computer-generated playlists correspond to the master or “skeleton” playlist, which may, for example, be provided as an XML file, in the order and identity of movies included therewithin, other than, at times, movies at the end of the playlist, and/or movies indicated to be of low priority viewing, which may not be included in some or all of the family of computer-generated playlists e.g. due to a plethora of campaign materials. Also, movies tagged as being unsuited for a particular screening location may be omitted at that location such as children's movies in a businessman-oriented hotel. Typically, the master playlist includes optional filler material, such as promo's, which is used to fill in e.g. between an actual end-time of an item on the playlist, and a desired “rounded” end-time, or between a list item on the playlist and the end-of-day time e.g. 2400:00.

Typically, all campaign material in the “campaign database” which is assigned to an individual screening location appears in the location's computer-generated playlists even if some movies on the master playlist need to be omitted for this purpose. A particular advantage of certain embodiments is that the campaign database, for example, may be updated at frequent intervals, e.g. once per hour, and due to the automated nature of playlist “family” generation, this does not disrupt smooth screening of video materials at each and every screening location. The master playlist, and optionally the family of computer-generated playlists, may be generated at or by a central server and screening location-local servers may receive information accordingly from the central server and may control the screening process accordingly at their location.

According to certain embodiments, a campaign database may be updated at any time with video material and metadata associated therewith, representing new or updated campaigns.

A particular advantage of the automated playlist “family” generation shown and described herein is that the playlist may frequently, e.g. periodically, for example every hour, recomputed the playlist and send the recomputed playlist to the location-local servers. Thus new campaign may be easily updated or added and the latest playlist is automatically generated to contain the most recent updates.

The digital broadcast, to which video content may be converted in accordance with certain embodiments of the present invention, maybe of any known standard, such as but not limited to one of the DVB standards, ATSC standards, ISDB standards, DTMB standards, DMB standards or any other digital broadcast standard. Any reference to digital broadcast(s) in this document may relate to any suitable one of the above digital broadcast standard(s).

Partial or complete control of the content for closed circuit broadcasting may be provided via the Internet e.g. for advertisers and TV broadcasts and/or by using administration web pages or a dedicated administration control application.

According to another embodiment of the present invention, there is provided a method for closed circuit broadcasting via terrestrial format comprising converting content from Internet format and/or from audio/video files to suitably formatted digital broadcasts.

The local server typically includes suitable computer storage for storing some or all of the data described herein e.g. a hard disk.

According to an embodiment of the invention, rather than decoding as described herein, the server may receive video files e.g. from Internet and store them on local storage. The files may be opened when they are to be played as determined by the playlist defined for the local server. The server extracts the audio and video packets therefrom, some or all the chain of processing shown and described herein is performed e.g. some or all of stream multiplexing, remuxing to normalize the bitrate, PCR insertion if and as suitable, splicing if and as suitable, and/or PAT, PMT, EPG and EIT creation, and the resulting multiplexed stream is sent to a player which typically comprises a computer card such as DTA-111 or DTA-110T. The player typically finalizes encoding and extracts the transport stream in the specified digital format over RF cable.

Some or all of the computational elements shown and described herein may be implemented on a processor e.g. may comprise a module in a processor.

While the invention has been described with respect to a limited number of embodiments, it will be appreciated that many variations, modifications and other applications of the invention may be made, e.g. using state of the art MPEG, Transport Stream, SQL, Algorithm and real-time computing technology. It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

Features of the present invention which are described in the context of separate embodiments may also be provided in combination in a single embodiment. Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

1. A system for closed circuit broadcasting comprising:
at least one central server coupled by a computer network such as internet to at least one local server for closed circuit broadcasting to one or more TVs at a local site;
wherein the central server is configured to select content from the internet and to receive files downloaded to it, and to arrange the selected content for subsequent close circuit broadcasting on at least one channel of the closed circuit television network in accordance with a schedule, and wherein the local server is configured for receiving the selected content in internet data format from the at least one central server and for close circuit broadcasting the selected content over the closed circuit TV network for receiving by at least one monitor.

2. The system of claim 1 wherein the at least one local server further comprises at least one of:
(a) a digital TV native decoder configured to reformat the internet content into a format selected from the group consisting of DVB-t, DVB-c, ATSC and QUM, for transmitting the decoded content, and
(b) a multiplexer for multiplexing and transmitting a plurality of channels in real time over the closed circuit TV network.

3. The system of claim 1 wherein the internet communication between the at least one central server and the at least local server comprises a virtual private network (VPN).

4. The system of claim 1 wherein the at least one local server is configured for close circuit broadcasting over the at least one channel in accordance with a preloaded play list stored in a database.

5. A method for providing content to one or more TVs at one or more local sites, the method comprising:
at least one central server, selecting at least one selection of content to be transmitted over an internet to at least one local server;
transmitting the at least one selection of content in internet data format from the at least one central server to the at least one local server; accumulating the at least one selection of content at the at least one local server;
scheduling the at least one selection of content to be close circuit broadcast in at least one channel to the one or more TVs, in accordance with a schedule provided by the at least one central server, and locally close circuit broadcasting the selection of content on the at least one channel for reception at and playing on the one or more local TVs at the one or more local sites.

6. The method of claim 5 wherein the at least one selection of content comprises at least one of the group consisting of data streaming over an internet, internet files, video files, video streams, audio files and audio streams and media files.

7. The method of claim 5 wherein said at least one selection of content comprises advertisements.

8. The method of claim 5 wherein the transmitting of the at least one selection of content from the at least one central server to the at least one local server is via a VPN.

9. The method of claim 5, wherein the local server receives content in the internet data format and converts it into a format for closed circuit broadcasting.

10. The method of claim 9 wherein said closed circuit broadcasting is through cables.

11. The method of claim 5 wherein the local server receives internet data from the central server and divides it into video and audio frames for further processing to transmit as a transport stream to local televisions as a closed circuit broadcast.

12. The method of claim 11 wherein in the local server each of said frames is sized to fit into transport stream packets.

13. The method of claim 12 wherein periodically, a PCR (Program Clock reference) is inserted into a header of said transport stream packets.

14. The method of claim 13 further comprising inserting a splicing point into the transport stream wherein said video frames comprise MPEG frames and the method further comprises marking a certain video frame as having a Presentation Time Stamp (PTS), which if the Presentation Time Stamp of the certain video frame is lower than a Presentation Time Stamp of a previous frame, marking the certain video frame as a new input for the at least one channel.

15. The method of claim 14 wherein the splicing point is counted down before inserting into the transport stream.

16. The method of claim 15 wherein if there is no efficient way of detecting an end of a stream countable as transport stream packets, a blank frame is injected.

17. The method of claim 16 wherein the blank frame is split into transport stream packets, and each of the packets includes a Splicing Point Flag turned on and a Splice Countdown integer set, indicating after how many more transport stream (TS) packets the next splicing point occurs.

18. The method of claim 16 wherein the transport stream constructed by the local server comprises at least one guide selected from the group consisting of:
a PAT (Program Association Table) including information regarding the at least one channel, and
a PMT (Program Map Table) containing specific information regarding each channel;
an EIT (Event Information Table) table, and an EPG (Electronic Program Guide) comprising information from a playlist guide for all channels.

19. The method of claim 18 wherein said guides are inserted periodically into the transport stream.

20. The method of claim 19 wherein every elementary stream (video or audio) is represented in the transmission stream as often as possible, in order to prevent starvation of an elementary stream.

21. The method of claim 20 wherein each transport stream packet is inserted into a channel queue and wherein, if all the channel queues contain more than a predetermined number of packets, flushing the packets from the channel queues.

22. The method of claim 21 wherein, said flushing comprises popping a packet from each channel queue and inserting it into the transport stream.

23. The method of claim 22 wherein said flushing utilizes a round robin algorithm to ensure that each channel in the transport stream has an equal packet consistency.

24. The method of claim 23 wherein the round robin algorithm further applies a limitation selected from the group consisting of:
considering the number of elements in each queue;
ensuring that all the queues are drained, and ensuring that all the queues are well spread within the TS.

25. The method of claim 24 wherein for each channel comprises an audio elementary stream and a video elementary stream and a frequency of appearances of an audio queue within the transmission stream is selected by comparison of the audio elementary stream with the video elementary stream of a considered channel before flushing the queues to ensure audio-visual synchronization.

26. The method of claim 25 wherein all available channels are considered in turn and a packet is popped from each channel.

27. The method of claim 24 wherein said packet is selected from the group consisting of video packets and audio packets, depending on the frequency of appearances of an audio queue for the considered channel.

28. A central server for selecting content from an internet and for receiving content files downloaded thereto;
matching said content into at least one channel;
creating a playlist of programs and schedule for the at least one channel;
transmitting the content to a local server for close circuit TV broadcasting as a transport stream on the at least one channel in accordance with the playlist.

29. A local server configured to receive at least one configuration for at least one channel, a playlist of programs and a schedule from a central server, and to close circuit broadcast the playlist over the at least one channel.

30. The system of claim 1 wherein the at least one local server further comprises at least one of:
(a) a digital TV native decoder configured to reformat the internet content into a digital broadcasting format, and
(b) a multiplexer for multiplexing and transmitting a plurality of channels in real time over the closed circuit TV network.

31. The method of claim 5 wherein said scheduling comprises computerized creation of a “family” of computerized playlists including a plurality of playlists, each including movies and embedded commercials, for each of a corresponding plurality of screening locations.

32. The method of claim 31 wherein the computerized creation comprises:
providing a computerized master playlist including:
video files respectively representing movies; and
video-less placeholders for commercial breaks;
providing a database of video files representing campaigns, including, for at least an individual video file from among the video files, an indication of relevance of said individual video file to at least some of the plurality of screening locations and an indication of said individual video file's priority relative to at least one video file other than said individual video file; and
for each individual screen location from among said screen locations, using a processor to generate a screen location-specific version of the master playlist characterized in that campaigns relevant the screen location are included in the playlist.

33. The method of claim 32 wherein said processor is operative as follows:
for each of said video files in said master playlist, generating a file entry using the video file's path;
for each individual placeholder from among said video-less placeholders, creating at least one entry in the playlist within the placeholder, including selecting video files, to constitute said at least one entry, from the database, in order of priority and only if relevant to said individual screening location;
if eventual playlist length exceeds a predetermined length, trimming at least one movie from the playlist until said eventual playlist length no longer exceeds the predetermined length; and
modifying the playlist by delaying each movie's starting point to a rounded starting time.

34. The method of claim 32 wherein said providing a database of video files representing campaigns includes providing, for each of said video files, a binary data field recording a relevant/not relevant indication for each of the plurality of screening locations.

35. The method of claim 33 wherein said predetermined length comprises 24 hours.

36. The method of claim 33 wherein said delaying defines blank time intervals and wherein said modifying also comprises inserting into the playlist, portions of a pre-stored filler item to fill the blank time intervals.
